(19) United States
(12) Patent Application Publication
(10) Pub. No.: US 2026/0194360 A1
(43) Pub. Date: Jul. 9, 2026

(54) AUGMENTED REALITY-BASED SYSTEM AND METHOD FOR PROVIDING NAVIGATION USING A ROUTE BASED SPATIAL REFERENCE

(71) Applicants: Jacob Elmon, London (GB); Brandon Elmon, London (GB)

(72) Inventors: Jacob Elmon, London (GB); Brandon Elmon, London (GB)

(21) Appl. No.: 19/553,564

(22) Filed: Mar. 2, 2026

Related U.S. Application Data
(63) Continuation-in-part of application No. 18/438,573, filed on Feb. 12, 2024.

(51) Int. Cl. G01C 21/36; G06T 7/73; G06T 19/00

(52) U.S. Cl. CPC G01C 21/3644; G06T 7/73; G06T 19/006; G06T 2207/30181; G06T 2207/30244

(57) ABSTRACT

The present invention relates to a system and method for augmented reality-based system and method for providing navigation using a route based spatial reference. The system comprises a navigation device incorporating sensors, a database and a computing device. The computing device receives a route data based on an input travel data to generate a route corridor representation which defines a spatial constraint of the travel route. The computing device receives data from sensors for estimating pose of the navigation device relative to the route corridor representation. The estimated pose comprises a longitudinal position along the travel route, a lateral offset relative to the travel route, and an orientation relative to a direction of the travel route. The computing device generates and display navigation related elements anchored along the route corridor representation, from the estimated pose for navigation.

### CROSS REFERENCE TO RELATED APPLICATION

The present application is a continuation-in-part of the U.S. patent application Ser. No. US 18/438,573, filed on Feb. 12, 2024, the contents of which are hereby incorporated by reference in their entirety.

### TECHNICAL FIELD

The present invention generally relates to a navigation system. More particularly, the present invention relates to an augmented reality (AR)-based system and method for providing navigation and controlling drift of a device position relative to a route using a route based spatial reference.

### BACKGROUND

Conventional navigation systems provide guidance using maps and often face challenges in maintaining reliable and consistent guidance under varying operating conditions. Augmented reality navigation systems attempt to improve usability by overlaying guidance onto a live view of the environment. However, existing approaches typically rely on estimating a full world-space pose of the device for navigation. Such approaches are computationally intensive, sensitive to sensor noise, and prone to accumulated tracking drift, particularly during continuous motion, high-speed travel, or in visually sparse environments.

As a result, augmented reality navigation overlays may become unstable, misaligned with the intended route, or visually inconsistent over time. Errors in orientation and lateral position estimation can cause guidance graphics to shift relative to the road or path being followed, reducing user trust and potentially impairing navigation effectiveness.

Further, a few related patents references are discussed as follows,

US11085786B2 of Apple Inc entitled “Navigation using augmented reality” discloses a device and a computer-implemented method for guiding a user along a route. The method includes a route server providing route information on geographical positions of roads and designated lanes for a plurality of segments along the route, to the device for travelling. The method includes receiving by the device a series of images captured by a camera along the route. The series of images provides a horizon and one or more available lanes along the route for travelling. The method further includes identifying one or more designated lanes from the one or more available lanes upon analyzing the series of images. Further, the method includes displaying to the user the series of images along with a navigational layer superimposed over the series of images. The navigational layer comprises a blocked region covering areas of the series of images outside of the one or more designated lanes and below the horizon.

US11333506B2 of Google LLC entitled “Computer-vision based positioning for augmented reality navigation” discloses systems and methods for displaying Augmented Reality (AR) indications during navigation. The system captures a live image of a scene. The system further generates navigation instructions and a navigation indication to be displayed. A computer vision-based positioning algorithm is performed on the live image of the scene to determine the relative position between a viewpoint of the device and one or more landmarks in the live image. The location or shape of the visual display of the navigation indication is determined based on the computer vision-based positioning algorithm.

However, the technologies disclosed by Apple Inc and Google LLC rely on world referenced pose estimation and visually detected scene features, which may introduce instability or misalignment when visual conditions change, landmarks are unreliable, or estimation errors accumulate over time. Further, the existing systems also lack mechanisms that sufficiently manage drift of device position relative to a navigation route.

Accordingly, there exists a need for a navigation system and method capable of providing augmented reality guidance that remains stably aligned with an intended route while reducing dependence on full world reconstruction and reducing positional drift that develops over time.

### SUMMARY

The present invention discloses an AR-based system for providing navigation. The system comprises a navigation device comprising one or more sensors. The navigation device is associated with a user. The system further comprises a database configured to store user data, navigation data associated with the navigation device, and travel route data including travel routes and landmark. Further the system comprises a computing device in communication with the navigation device and the database. The computing device comprises a memory storing a set of program modules and a processor configured to execute the program modules. The set of program modules comprises a route module, a sensor data processing module, a tracking module, an augmented reality rendering module, a landmark module, a drift management module, and a corridor bounded visual tracking module.

The route module is configured to receive a route data based on an input travel data. The route data comprises information including a travel route. Further, the route module is configured to generate a route corridor representation defining a spatial constraint of the travel route. The route corridor representation serves as a spatial reference for determining the location of the navigation device in the travel route during navigation. The sensor data processing module is configured to receive sensor data from the one or more sensors.

The tracking module is configured to estimate pose of the navigation device relative to the route corridor representation based on the sensor data. The estimated pose comprises a longitudinal position along the travel route, a lateral offset relative to the travel route, and an orientation relative to a direction of the travel route. The sensor data processing module configured to fuse sensor data to update the estimated pose of the navigation device. The augmented reality rendering module configured to generate and display navigation related elements anchored along the route corridor representation based on the estimated pose for navigation.

The sensor data processing module is configured to process sensor data including camera data to extract environmental data including environmental features associated with the travel route, and assign confidence weights to the extracted environmental features and the sensor data. The landmark module in communication with the sensor data processing module is configured to detect an environmental feature corresponding to a landmark associated with the travel route. Further, the landmark module is configured to perform a soft correction of the estimated pose of the navigation device when the environmental feature corresponds to the landmark and upon satisfaction of confidence and temporal consistency conditions. Influence of the correction decays when the landmark is no longer observed. Further the landmark module is configured to apply rejection conditions prior to performing pose correction. In one embodiment, the rejection conditions comprising at least one of: a landmark detection confidence exceeding a predefined threshold, temporal consistency across multiple frames of camera data, agreement with predicted landmark visibility based on progress along the travel route, and agreement with expected camera orientation relative to the route. Furthermore, landmark module is configured to perform the soft correction of the estimated pose when the rejection conditions are satisfied. The correction is applied incrementally to the estimated pose over successive time intervals using a time dependent weighting factor.

The AR rendering module in communication with the tracking module is configured to providing an abstract visual representation of the travel route if at least one of the speed and tracking confidence is beyond the predefined threshold. Further, the AR rendering module is configured to display navigation related elements anchored along the route corridor representation based on the estimated pose if at least one of the speed and tracking confidence is within the predefined threshold. The AR rendering module is configured to display navigation related elements positioned based on the estimated pose with spatial alignment corresponding to roadway lane structure.

The tracking module in communication with the sensor data processing module is configured to monitor speed and tracking confidence of the navigation device and determine if at least one of speed and tracking confidence is within a predefined threshold.

The drift management module is configured to determine a lateral deviation of a position of the navigation device relative to the route corridor representation and an orientation deviation relative to a route direction. Further, the drift management module is configured to compare the lateral deviation and the orientation deviation to predefined deviation thresholds. Further, the drift management module is configured to treat the route corridor representation as a soft geometric constraint when the lateral deviation and the orientation deviation are within the predefined deviation thresholds. The drift management module is further configured to correct the estimated pose relative to the travel route using route relative parameters when at least one of the lateral deviation and the orientation deviation exceeds the predefined deviation thresholds. Further, the drift management module is configured to apply a drift correction process that gradually adjusts estimated device position relative to the route corridor representation based on visual features observed over time.

The corridor bounded visual tracking module is configured to select visual features within a predicted field of view of the route corridor representation. Further, the corridor bounded visual tracking module is configured to track the selected visual features for a limited duration. Further, the corridor bounded visual tracking module is configured to determine an orientation observability condition relative to the travel route based on the tracked visual features. Further, the corridor bounded visual tracking module is configured to apply supplemental orientation correction when the orientation observability condition satisfies a predefined criterion. The corridor bounded visual tracking module is further configured to use feature tracking residuals to update lateral offset and orientation relative to the route. Further, the corridor bounded visual tracking module is configured to perform pose estimation without global mapping, loop closure, and simultaneous localization and mapping.

In an embodiment, the sensors comprise at least one of camera, an inertial measurement unit (IMU), a positioning sensor comprising at least one of a global positioning system (GPS) module and a global navigation satellite system (GNSS) module, magnetometer, barometer, and motion sensors. The sensors are configured to collect sensor data. The sensor data comprises camera data, motion data including inertial data and position data.

Further, in an embodiment, the route corridor representation comprises a three-dimensional structure extending along the travel route. The three-dimensional structure is selected from the group consisting of a mesh, a spline, a ribbon, a tube, and a parametric surface. In one embodiment, an AR-based method for providing navigation is disclosed. The method is executed in a system comprising a navigation device incorporating one or more sensors, a database, and a computing device in communication with the navigation device and the database. The navigation device is associated with a user. Further, the database configured to store user data, navigation data associated with the navigation device, and travel route data including travel routes and landmark. The computing device comprises a memory storing a set of program modules and a processor configured to execute the program modules.

At one step, the route module is configured to receive a route data based on an input travel data. The route data comprises information including a travel route. At another step, the route module is further configured to generate a route corridor representation defining a spatial constraint of the travel route. The route corridor representation serves as a spatial reference for determining the location of the navigation device in the travel route during navigation.

At yet another step, the sensor data processing module is configured to receive, sensor data from the one or more sensors of the navigation device. In an embodiment, the sensors comprise at least one of camera, an inertial measurement unit (IMU), a positioning sensor comprising at least one of a global positioning system (GPS) module and a global navigation satellite system (GNSS) module, magnetometer, barometer, and motion sensors. The sensors are configured to collect sensor data. The sensor data comprises camera data, motion data including inertial data and position data.

In an embodiment, the route corridor representation comprises a three-dimensional structure extending along the travel route. The three-dimensional structure is selected from the group consisting of a mesh, a spline, a ribbon, a tube, and a parametric surface. At yet another step, the tracking module is configured to estimate, pose of the navigation device relative to the route corridor representation based on the sensor data. The estimated pose comprises a longitudinal position along the travel route, a lateral offset relative to the travel route, and an orientation relative to a direction of the travel route. The sensor data processing module configured to fuse sensor data to update the estimated pose of the navigation device. At yet another step, the augmented reality rendering module is configured to generate and display, navigation related elements anchored along the route corridor representation based on the estimated pose for navigation. At yet another step, the sensor data processing module is further configured to process sensor data including camera data to extract environmental data including environmental features associated with the travel route.

At yet another step the sensor data processing module is further configured to assign confidence weights to the extracted environmental features and to the sensor data. At yet another step, the landmark module is configured to detect, an environmental feature corresponding to a landmark associated with the travel route. The landmark module is in communication with the sensor data processing module. At yet another step, the landmark module is further configured to perform, a soft correction of the estimated pose of the navigation device when the environmental feature corresponds to the landmark and upon satisfaction of confidence and temporal consistency conditions. Influence of the correction decays when the landmark is no longer observed.

At yet another step, the landmark module is further configured to process, one or more rejection conditions prior to performing pose correction. The landmark module is in communication with the sensor data processing module. In an embodiment, the rejection conditions comprising at least one of: a landmark detection confidence exceeding a predefined threshold, temporal consistency across multiple frames of camera data; agreement with predicted landmark visibility based on progress along the travel route, and agreement with expected camera orientation relative to the route.

At yet another step, the landmark module is further configured to perform, the soft correction of the estimated pose of the navigation device when the rejection conditions are satisfied. The correction is applied incrementally to the estimated pose over successive time intervals using a time dependent weighting factor. At yet another step, the tracking module is further configured to monitor, speed and tracking confidence of the navigation device to determine if at least one of speed and tracking confidence is within a predefined threshold. The tracking module is in communication with the sensor data processing module.

At yet another step, the augmented reality rendering module is further configured to provide, an abstract visual representation of the travel route if at least one of the speed and the tracking confidence is beyond the predefined threshold. The augmented reality rendering module is in communication with the tracking module. In an embodiment, the abstract visual representation comprises at least one of: abstract directional indicators, route-conforming ribbons without precise lane alignment, and symbolic cues presented with reduced spatial anchoring requirements.

At yet another step, the augmented reality rendering module is further configured to display, navigation related elements anchored along the route corridor representation based on the estimated pose if at least one of the speed and the tracking confidence is within the predefined threshold. At yet another step, the augmented reality rendering module is further configured to display, navigation related elements positioned based on the estimated pose with spatial alignment corresponding to roadway lane structure.

At yet another step, the drift management module is configured to determine, a lateral deviation of a position of the navigation device relative to the route corridor representation and an orientation deviation relative to a route direction. At yet another step, the drift management module is further configured to compare, the lateral deviation and the orientation deviation to predefined deviation thresholds. At yet another step, the drift management module is further configured to treat, the route corridor representation as a soft geometric constraint when the lateral deviation and the orientation deviation are within the predefined deviation thresholds.

At yet another step, the drift management module is further configured to, the estimated pose relative to the travel route using route relative parameters when at least one of the lateral deviation and the orientation deviation exceeds the predefined deviation thresholds. At yet another step, the drift management module is further configured to apply, a drift correction process that gradually adjusts estimated device position relative to the route corridor representation based on visual features observed over time.

At yet another step, the corridor bounded visual tracking module is configured to select, visual features within a predicted field of view of the route corridor representation. At yet another step, the corridor bounded visual tracking module is further configured to track, the selected visual features for a limited duration.

At yet another step, the corridor bounded visual tracking module is further configured to determine, an orientation observability condition relative to the travel route based on the tracked visual features. At yet another step, the corridor bounded visual tracking module is further configured to apply, supplemental orientation correction when the orientation observability condition satisfies a predefined criterion. At yet another step, the corridor bounded visual tracking module is further configured to update, lateral offset and orientation relative to the route using feature tracking residuals. At yet another step, the corridor bounded visual tracking module is further configured to estimate, the navigation device pose without performing global mapping, loop closure, and simultaneous localization and mapping.

The present invention provides an augmented reality (AR)-based navigation system comprising a navigation device having one or more sensors, a database storing route and landmark data, and a computing device configured to execute program modules that implement a SLAM-free, route-constrained AR tracking architecture. A route module receives route data based on input travel data and generates a three-dimensional deformable route corridor representation extending along the travel route, the route corridor representation defining a bounded spatial corridor that serves as a sole spatial reference frame for navigation. A sensor data processing module receives and fuses sensor data from the one or more sensors, and a tracking module estimates a pose of the navigation device exclusively relative to the route corridor representation without estimating or maintaining a global six degree-of-freedom (6-DoF) world pose. The pose is represented in a reduced route-relative state space comprising a longitudinal progress parameter corresponding to position along the travel route (s), a lateral offset parameter relative to the travel route (l), and a heading parameter relative to a direction of the travel route (θᵣ), wherein pose estimation is constrained to remain within the bounded spatial corridor and wherein the corridor is treated as a soft geometric constraint permitting bounded deviation from mapped geometry to account for map inaccuracies.

The tracking module is further configured to maintain overlay stability under vehicle-speed travel conditions and under degraded visual observability by performing coordinated, route-relative orientation stabilization of the heading parameter through a multi-source yaw robustness pipeline. The pipeline combines independent orientation observability sources including visual vanishing point estimation derived from camera data, inertial measurement unit (IMU) bias smoothing, satellite-based heading change measurements, corridor-bounded short-term visual feature tracking residuals, and intermittent landmark-based orientation corrections. The system thereby mitigates heading drift during straight-route travel and other low-observability scenarios without constructing or maintaining a persistent global map, without loop closure, and without performing simultaneous localization and mapping (SLAM).

The system further includes a landmark processing mechanism configured to detect environmental features corresponding to stored route landmarks and to apply multi-stage rejection conditions prior to any correction, the rejection conditions including confidence thresholds, temporal consistency across frames, predicted visibility based on route progress, and expected camera-to-route orientation agreement. Upon satisfaction of the rejection conditions, the system applies soft, incremental pose corrections using a time-dependent weighting factor, wherein the influence of landmark corrections decays when the landmark is no longer observed, thereby preventing abrupt spatial discontinuities in AR overlays.

A corridor-bounded visual tracking module selects and tracks visual features only within a predicted field of view of the route corridor representation and retains such features for a limited temporal duration without persistence beyond short tracking windows, without constructing a global feature database, and without establishing a global coordinate frame, such that the feature tracking subsystem is structurally incapable of forming a SLAM system. Feature tracking residuals contribute only to refinement of lateral offset and heading within the reduced route-relative state.

The system further incorporates confidence-aware and speed-dependent operational modes, wherein tracking confidence and vehicle speed are monitored and, upon degradation of confidence or exceedance of predefined speed thresholds, the augmented reality rendering module adaptively modifies overlay anchoring fidelity and spatial precision requirements to maintain user-perceived stability and prevent misleading spatial alignment. The augmented reality rendering module generates and displays navigation-related elements anchored solely to the route corridor representation based on the route-relative pose, such that rendered elements are spatially stabilized by the route-constrained architecture rather than by a global world coordinate frame.

Therefore, the coordinated interaction of route-constrained pose estimation, soft map-error-tolerant geometric modelling, multi-layer landmark rejection with decaying correction influence, multi-source yaw stabilization, corridor-bounded short-term feature tracking incapable of SLAM, and confidence-aware adaptive rendering forms a unified, SLAM-free AR navigation tracking architecture that maintains stable augmented reality overlays at vehicle speeds and under adverse sensing conditions where conventional world-anchored AR tracking systems experience drift, instability, or tracking loss.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 exemplarily illustrates an environment of an augmented reality-based system for providing navigation using a route based spatial reference, according to an embodiment of the present invention.

FIG. 2 exemplarily illustrates a block diagram of the augmented reality-based system for providing navigation using a route based spatial reference, according to an embodiment of the present invention.

FIG. 3 exemplarily illustrates a flowchart of a method for providing AR-based navigation using a route based spatial reference, according to an embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

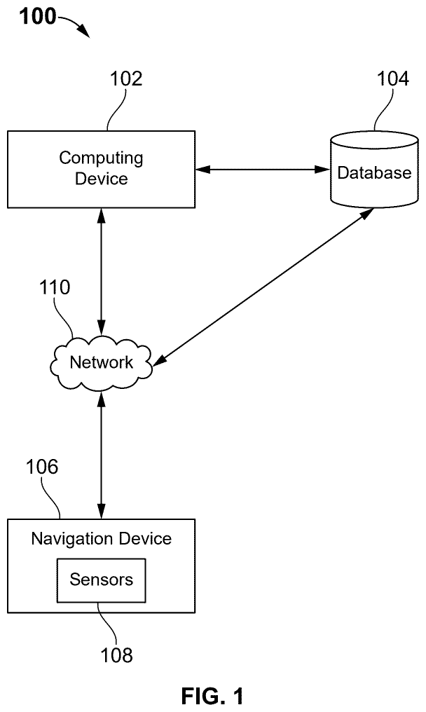

FIG. 1 exemplarily illustrates an environment 100 of an augmented reality-based system for providing navigation using a route based spatial reference, according to an embodiment of the present invention. The system comprises at least one computing device 102 and at least one database 104 in communication with the computing device 102. The system further comprises at least one navigation device 106 associated with a user. The navigation device 106 comprises one or more sensors 108 configured to capture environmental and motion related data. The computing device 102, the navigation device 106, and the database 104 are in communication via a network 110.

The computing device 102 is configured to receive a travel route from a travel data, generate a route corridor representation of the travel route, estimate a pose of the navigation device 106 relative to the route corridor representation, and generate and display augmented reality navigation guidance based on the estimated pose.

The navigation device 106 is configured to provide an interface for presenting navigation guidance to the user. The interface may include an application executable on the navigation device 106 that enables communication with the computing device 102 via the network 110.

The navigation device 106 comprises one or more sensors 108 configured to generate sensor data associated with a travel route and navigation device 106. The sensors 108 comprise at least one of camera, an inertial measurement unit (IMU), a positioning sensor comprising at least one of a global positioning system (GPS) module and a global navigation satellite system (GNSS) module, magnetometer, barometer, and motion sensors.

The navigation device 106 is further configured to display augmented reality navigation elements aligned with the route corridor representation. As used herein, the term navigation device 106 includes a portable computing device configured to provide navigation guidance, including but not limited to a smartphone, a head mounted display, or an in-vehicle display.

The network 110 represents one or more interconnected communication networks over which the computing device 102, the navigation device 106, and the database 104 communicate. The network 110 may include packet based wide area networks, local area networks, wireless networks, cellular networks, satellite networks, or combinations thereof. The network 110 may be implemented as a wired network, a wireless network, or a combination thereof.

The database 104 is in communication with the computing device 102 and is configured to store user data, navigation data associated with the navigation device 106, travel route data including travel routes and landmark. In one embodiment, the database 104 resides within the computing device 102. In another embodiment, the database 104 resides remotely from the computing device 102. The database 104 further comprises memory configured to store at least one of route data, route corridor representations, landmark data, sensor calibration data, and tracking parameters used for route relative pose estimation.

The computing device 102 may include at least one of a server, a general purpose computer, a special purpose computer, a workstation, or a distributed computing system. Although illustrated as a single device, the functions of the computing device 102 may be performed by multiple computing devices operating in a distributed environment. The computing device 102 is configured to process sensor data received from the navigation device 106, estimate device pose relative to a route corridor representation, and generate augmented reality navigation guidance constrained to the travel route. In another embodiment, the computing device 102 is a part of the navigation device 106.

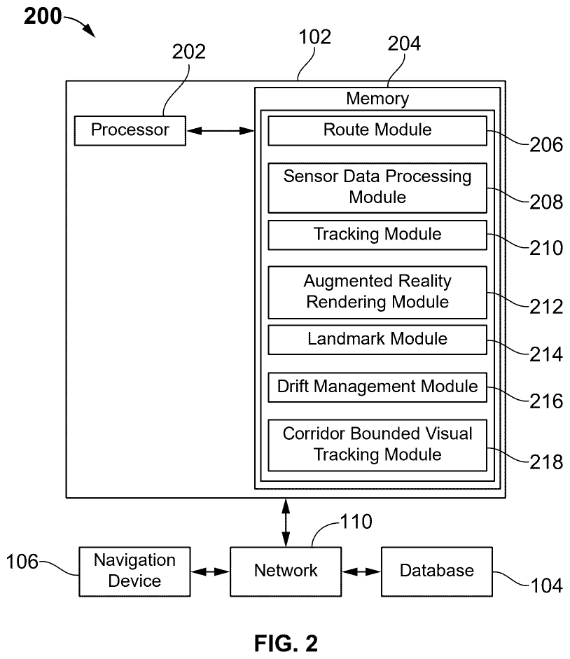

FIG. 2 exemplarily illustrates a block diagram 200 of the augmented reality-based system for providing navigation using a route based spatial reference, according to an embodiment of the present invention. The computing device 102 comprises one or more processors 202 and one or more memories 204. The computing device 102 further comprises an augmented reality (AR) module. The computing device 102 is in communication with the navigation device 106. The memory 204 is configured to store a set of program modules. The processor 202 is configured to execute one or more program modules. The program modules comprise a route module 206, a sensor data processing module 208, a tracking module 210, an augmented reality rendering module 212, a landmark module 214, a drift management module 216 and a corridor bounded visual tracking module 218.

The navigation device 106 comprising one or more sensors 108 is associated with a user. The sensors 108 are configured to collect sensor data. The sensor data comprises camera data, motion data including inertial data and position data. The route module 206 is configured to receive a route data based on an input travel data. The input travel data include a starting location and a destination location. The route data comprises information including a travel route. The route module 206 is configured to generate a route corridor representation defining a spatial constraint or a bounded region of the travel route. The route corridor representation serves as a spatial reference for determining the location of the navigation device 106 in the travel route during navigation.

The route corridor representation comprises a three-dimensional structure extending along the travel route. The three-dimensional structure is selected from the group consisting of a mesh, a spline, a ribbon, a tube, and a parametric surface.

The sensor data processing module 208 is configured to receive sensor data from one or more sensors 108 associated with the navigation device 106. The tracking module 210 is configured to estimate the pose of the navigation device 106 relative to the route corridor representation based on the sensor data. The estimated pose comprises a longitudinal position along the travel route, a lateral offset relative to the travel route, and an orientation relative to a direction of the travel route. The sensor data processing module 208 is further configured to fuse the sensor data to support estimation and updating of a pose of the navigation device 106 relative to the route corridor representation. The augmented reality rendering module 212 is configured to generate and display navigation related elements anchored along the route corridor representation based on the estimated pose for navigation.

The sensor data processing module 208 is configured to process sensor data including camera data to extract environmental data including environmental features associated with the travel route. The sensor data processing module 208 is further configured to assign confidence weights to the extracted environmental features and to the sensor data.

The landmark module 214 is in communication with the sensor data processing module 208. The landmark module 214 is configured to detect an environmental feature corresponding to a landmark associated with the travel route. The landmark module 214 is further configured to perform a soft correction of the estimated pose of the navigation device 106 when the environmental feature corresponds to the landmark and upon satisfaction of confidence and temporal consistency conditions. An influence of the correction decays when the landmark is no longer observed.

The landmark module 214 is further configured to apply rejection conditions prior to performing pose correction. The rejection conditions comprise at least one of a landmark detection confidence exceeding a predefined threshold, temporal consistency across multiple frames of camera data, agreement with predicted landmark visibility based on progress along the travel route, and agreement with expected camera orientation relative to the route. The landmark module 214 is configured to perform the soft correction when the rejection conditions are satisfied, wherein the correction is applied incrementally to the estimated pose over successive time intervals using a time dependent weighting factor.

The tracking module 210 is in communication with the sensor data processing module 208 and is configured to monitor speed and tracking confidence of the navigation device 106 and determine whether at least one of speed and tracking confidence is within a predefined threshold. The augmented reality rendering module 212 is in communication with the tracking module 210 and is configured to provide an abstract visual representation of the travel route when at least one of the speed and tracking confidence is beyond the predefined threshold. The augmented reality rendering module 212 is configured to display navigation related elements anchored along the route corridor representation based on the estimated pose when at least one of the speed and tracking confidence is within the predefined threshold. The augmented reality rendering module 212 is further configured to display navigation related elements positioned based on the estimated pose with spatial alignment corresponding to roadway lane structure. The abstract visual representation comprises at least one of abstract directional indicators, route conforming ribbons without precise lane alignment, and symbolic cues presented with reduced spatial anchoring requirements.

The drift management module 216 is configured to determine a lateral deviation of a position of the navigation device 106 relative to the route corridor representation and an orientation deviation relative to a route direction. The drift management module 216 is configured to compare the lateral deviation and the orientation deviation to predefined deviation thresholds. The drift management module 216 is configured to treat the route corridor representation as a soft geometric constraint when the lateral deviation and the orientation deviation are within the predefined deviation thresholds. The drift management module 216 is further configured to correct the estimated pose relative to the travel route using route relative parameters when at least one of the lateral deviation and the orientation deviation exceeds the predefined deviation thresholds. The drift management module 216 is further configured to apply a drift correction process that gradually adjusts estimated device position relative to the route corridor representation based on visual features observed over time.

The corridor bounded visual tracking module 218 is configured to select visual features within a predicted field of view of the route corridor representation and track the selected visual features for a limited duration. The corridor bounded visual tracking module 218 is further configured to determine an orientation observability condition relative to the travel route based on the tracked visual features and apply supplemental orientation correction when the orientation observability condition satisfies a predefined criterion. The corridor bounded visual tracking module 218 is configured to use feature tracking residuals to update lateral offset and orientation relative to the route and to perform pose estimation without global mapping, loop closure, and simultaneous localization and mapping.

In another embodiment, the system is configured to receive a planned navigation route, resample the route into fixed spatial intervals, and compute, for each segment, geometric attributes including heading, curvature, elevation grade, and lane width. The system further generates a route corridor mesh representing a deformable ribbon centered along the navigation path. The mesh defining a spatial reference frame for augmented reality (AR) anchoring.

In another embodiment, the sensor data processing module 208 is configured to receive measurement data from a mobile device including a camera subsystem, an inertial measurement unit (IMU) subsystem, a global navigation satellite system (GNSS) subsystem, and optionally one or more additional sensors 108 including a magnetometer, wherein the received data streams are provided to visual processing and sensor fusion components.

In one embodiment, a visual processing module is configured to process captured image frames to extract road related cues, the module comprising a road segmentation unit configured to identify road surface regions, lanes, edges, and barriers; a vanishing point estimator configured to estimate road direction based on dominant line orientation; a repetition detector configured to identify periodic roadside structures to derive relative motion cues; and a landmark detection unit configured to match frame content against predicted route based landmark categories including intersections and bridges, wherein outputs of the visual processing module are provided to a sensor fusion module.

In one embodiment, the sensor data processing module 208 comprises a synchronization and preprocessing layer configured to temporally align IMU, GNSS, and image derived timestamps; a route coordinate state estimator configured to track user pose in a reduced state space including longitudinal progress(s), lateral offset (l), and relative heading (θᵣ), the estimator being constrained to the route corridor rather than a full six degree of freedom pose; an adaptive weighting engine configured to dynamically adjust sensor weighting based on operating conditions including vehicle speed and image clarity; and a drift suppression engine configured to apply geometric constraints derived from the route corridor mesh, lane boundaries, vanishing point alignment, and optionally landmark stamps.

In one embodiment, the landmark module 214 is configured to predict upcoming landmark categories from route metadata, compare live visual input against the predicted categories, generate a landmark stamp based on the comparison, and apply the landmark stamp progressively to correct pose drift without introducing visual discontinuity in AR overlays.

In one embodiment, the AR rendering module 212 is configured to receive a route relative pose estimate and project navigation overlays onto the route corridor mesh, the module comprising a route relative projection engine, a predictive overlay generator, a confidence aware rendering component, and a drift resistant mode controller, thereby maintaining stable AR alignment under conditions of reduced visual tracking quality. In one embodiment, a user interface module or the navigation device 106 is configured to display AR navigation cues, status indicators, and user interaction interfaces.

In operation, the system acquires and preprocesses a navigation route, receives real time camera, IMU, and GNSS data from a mobile device, extracts road geometry through visual segmentation and vanishing point detection, guides scene recognition using landmark predictions, estimates pose in route relative coordinates (s, l, θᵣ) through sensor fusion, suppresses drift using route based constraints and landmark stamps, and projects AR overlays onto the Route Corridor Mesh for rendering to a user.

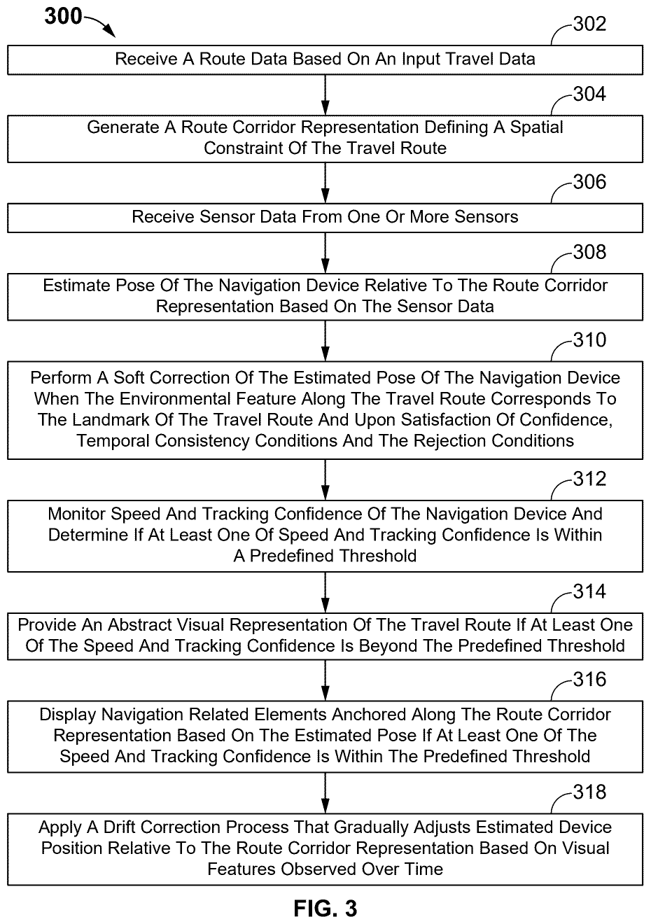

FIG. 3 exemplarily illustrates a flowchart 300 of a method for providing AR-based navigation using a route based spatial reference, according to an embodiment of the present invention. At step 302, the computing device 102 is configured to receive a route data based on an input travel data. At step 304, the computing device 102 is configured to generate a route corridor representation defining a spatial constraint of the travel route. At step 306, the computing device 102 is configured to receive sensor data from one or more sensors 108. At step 308, the computing device 102 is configured to estimate pose of the navigation device 106 relative to the route corridor representation based on the sensor data.

At step 310, the computing device 102 is configured to perform a soft correction of the estimated pose of the navigation device 108 when the environmental feature along the travel route corresponds to the landmark of the travel route and upon satisfaction of confidence, temporal consistency conditions and the rejection conditions.

At step 312, the computing device 102 is configured to monitor speed and tracking confidence of the navigation device 106 and determine if at least one of speed and tracking confidence is within a predefined threshold.

At step 314, the computing device 102 is configured to provide an abstract visual representation of the travel route if at least one of the speed and tracking confidence is beyond the predefined threshold.

At step 316, the computing device 102 is configured to display navigation related elements anchored along the route corridor representation based on the estimated pose if at least one of the speed and tracking confidence is within the predefined threshold.

At step 318, the computing device 102 is configured to apply a drift correction process that gradually adjusts estimated device position relative to the route corridor representation based on visual features observed over time.

In another embodiment, an operating environment of the system is described as follows. In another embodiment, the system comprises a route module 206 including a route acquisition unit configured to receive a navigation route from a mapping service, a route sampling and geometry unit configured to resample the route into uniform segments and compute route attributes including heading, curvature, elevation grade, lane width, and upcoming intersection and turn metadata, and a route corridor mesh generator configured to construct a deformable geometric mesh centered along the route. The mesh defining a coordinate system for augmented reality anchoring and drift suppression.

In another embodiment, the sensor data processing module 208 including a camera subsystem configured to capture image frames, an IMU subsystem configured to provide accelerometer and gyroscope measurements, a GNSS subsystem configured to provide global positioning updates, and optionally one or more additional device sensors 108 including a magnetometer, barometer, or motion sensors.

In another embodiment, the system further comprises a visual processing module including a road segmentation unit configured to identify road surface regions, lanes, edges, guardrails, or curbs, a vanishing point estimator configured to determine road heading direction from image structure, a roadside repetition detector configured to identify periodic structures to infer forward motion cues, and a landmark detection unit configured to match camera frames to predicted landmarks derived from the route.

In another embodiment, the sensor data processing module 208 including a preprocessing layer configured to normalize, timestamp, and synchronize IMU, camera, and GNSS measurements, a route coordinate state estimator configured to maintain pose in terms of longitudinal progress(s), lateral offset (l), and relative heading (θᵣ) by dynamically fusing IMU derived heading and acceleration, camera derived lateral and heading cues, and GNSS derived projected position on the Route Corridor Mesh, an adaptive weighting engine configured to adjust sensor confidence weights based on motion speed, image quality, lighting conditions, and sensor reliability, and a drift suppression engine configured to apply route corridor geometric constraints, lane boundaries, vanishing point alignment, heading consistency rules, and Landmark Stamp corrections to restrict tracking to route geometry.

In another embodiment, the system further comprises a landmark module 214 including a landmark predictor configured to anticipate semantic structures ahead based on route metadata, a landmark matcher configured to compare live visual data with predicted landmark categories, and a Landmark Stamp generator configured to produce correction signals for longitudinal progress(s), lateral offset (l), and relative heading (θᵣ), the correction signals being smoothed over a defined temporal window to avoid abrupt augmented reality transitions.

In another embodiment, the AR rendering module 212 including a route relative projection engine configured to place augmented reality objects onto the Route Corridor Mesh, a predictive overlay generator configured to position augmented reality elements ahead of a user by projecting through mesh curvature, slope, and predicted path, a confidence aware rendering unit configured to adjust presentation characteristics based on tracking confidence, and a drift resistant mode controller configured to enter a fallback mode utilizing IMU and GNSS inputs when visual tracking fails, thereby maintaining stable augmented reality placement relative to the Route Corridor Mesh.

In one embodiment, the system further comprises a system control module including a data flow manager configured to coordinate communication between modules, a timing and synchronization manager configured to ensure correct temporal ordering of sensor and visual data, and an error handling unit configured to monitor performance and reset or adjust modules when drift thresholds are exceeded. In one embodiment, the system further comprises a user interface layer including a navigation display unit configured to present augmented reality overlays aligned with a roadway, status and confidence indicators configured to display tracking confidence and fallback mode notifications, and a user interaction unit configured to accept input for route changes, recalculation, or configuration settings.

In another embodiment, a method for providing augmented reality (AR)-based navigation using a route-based spatial reference, executed within the operating environment, is disclosed as follows. The system is configured to receive a planned navigation route from a mapping service executing on a mobile device, convert the route into a uniformly sampled polyline representing sequential positions along a road network, and, for each sampled point, compute or retrieve route attributes including route heading, curvature, elevation grade, expected road width, and metadata corresponding to turns, intersections, and lane splits, wherein the system further generates a Route Corridor Mesh representing a curved navigable ribbon centered along the path of travel.

In one embodiment, during a sensor initialization stage, the mobile device activates onboard sensors 108 including a camera, an inertial measurement unit (IMU), and a global navigation satellite system (GNSS) module, and estimates initial values for longitudinal progress(s), lateral offset (l), and relative heading (θᵣ) based on GNSS location and initial device orientation.

In one embodiment, during a visual feature extraction stage, the system captures a video frame from the mobile device camera, applies a lightweight semantic segmentation process to identify visible road regions, lane markings, road edges, guardrails, curbs, or similar structural elements, computes a dominant vanishing direction from the frame using a vanishing point estimation module, and optionally identifies periodic roadside structures including lamps or posts using a repetition pattern detector to estimate relative forward motion cues.

In one embodiment, during a sensor measurement processing stage, IMU readings are processed to estimate short term heading rate, acceleration, and device orientation, GNSS readings, when available, provide coarse and substantially drift free updates of global position, and camera derived cues including segmentation edges, lane boundaries, and vanishing point estimates are converted into corrections for lateral offset (l) and heading offset (θᵣ).

In one embodiment, during a landmark prediction and detection stage, the system utilizes the Route Corridor Mesh to predict upcoming semantic landmarks along the route including intersections, bridges, signs, or notable structures, evaluates each captured frame for the presence of predicted landmarks using lightweight visual classifiers or template categories, generates a Landmark Stamp upon detection of a predicted landmark, the Landmark Stamp comprising a correction signal associated with an expected position on the route, and applies the Landmark Stamp gradually over a defined temporal window to reduce positional drift without introducing visible discontinuities in augmented reality overlays.

In one embodiment, during a route coordinate tracking stage, a state estimator maintains device pose in route relative coordinates comprising longitudinal progress(s), lateral offset (l), and relative heading (θᵣ), wherein IMU measurements predominantly update longitudinal progress(s) during high speed operation or periods of visual degradation, camera based measurements predominantly update lateral offset (l) and relative heading (θᵣ), GNSS measurements, when available, are projected onto the Route Corridor Mesh to provide coarse updates to longitudinal progress(s) and lateral offset (l), and the state estimator dynamically reweights sensor inputs based on estimated speed, environmental visibility, sensor confidence levels, and landmark detection events.

In one embodiment, during a drift suppression stage, the system enforces a constraint that the tracked device position remains within geometric boundaries of the Route Corridor Mesh to prevent accumulation of world space drift, suppresses heading drift through vanishing point alignment and conformity with route heading, suppresses lateral drift through road edge segmentation and expected route width boundaries, and suppresses longitudinal drift through integration of GNSS updates, IMU derived acceleration, and periodic Landmark Stamps.

In one embodiment, during an augmented reality overlay projection stage, an AR rendering engine receives the route relative pose estimate (s, l, θᵣ), computes future positions of navigation elements including arrows and lane guidance indicators by projecting the elements onto the Route Corridor Mesh rather than into world coordinates, dynamically adjusts the AR elements according to predicted curvature, elevation, and geometry of an upcoming roadway, activates a drift resistant mode when tracking confidence falls below a threshold such that overlays are maintained relative to route position rather than visual anchors, and renders frames for display to a user with overlays remaining visually aligned to the roadway during high speed motion.

In one embodiment, the system operates in a continuous update loop in which visual capture, sensor fusion, and route coordinate state estimation are repeated for each frame or sensor interval, and wherein the Route Corridor Mesh functions as a persistent geometric constraint throughout the tracking loop to ensure bounded error accumulation and sustained augmented reality stability.

The system incorporates multi-modal sensor fusion using a smartphone camera, an inertial measurement unit, and a satellite positioning sensor, together with knowledge of a predefined navigation route, to predict a future position of a user and pre-render augmented reality content at the predicted position. The system further provides predictive anchoring for advance adjustment of virtual element placement and hybrid augmented reality and virtual reality mode switching to maintain visual stability when camera tracking confidence is reduced. The system operates using sensors 108 natively available in a mobile device, thereby providing a hardware-independent, portable, and widely deployable navigation solution compatible with standard smartphone platforms.

The system operates using a phone camera, an inertial measurement unit, and a satellite positioning sensor without dependency on visual positioning services or street view data, and optionally performs low-compute road segmentation and vanishing point estimation. The system is designed for motorway-speed operation on a mobile phone using route constraints, wherein vision is used primarily to estimate lateral offset and relative heading, inertial and satellite positioning data are used to estimate route progress, and semantic landmark stamps provide soft drift correction.

The system constrains tracking to a route corridor mesh and estimates route progress, lateral offset, and relative heading on a mobile phone by fusing lightweight vision with inertial and satellite positioning data and applying semantic landmark stamps as time-smoothed corrections without world-based simultaneous localization and mapping or visual positioning services. The system renders augmented reality elements relative to the route corridor rather than world coordinates and operates in a drift-resistant mode when visual input degrades, enabling operation at highway speeds.

The system assigns a continuous confidence value controlling behavior, wherein high confidence enables full augmented reality fidelity, moderate confidence enables smoothing with increased inertial weighting, reduced confidence activates a mesh-only drift-resistant mode, and very low confidence suppresses augmented reality output and reverts to a minimal interface.

The route-constrained design eliminates dependence on full visual tracking by estimating only route progress, lateral offset, and relative heading, such that motion blur does not disrupt tracking, low parallax at high speed does not affect longitudinal estimation, and lateral and heading estimation remain stable under degraded imagery, thereby maintaining augmented reality alignment with the predefined route and bounding drift through route geometry rather than free three-dimensional pose estimation.

The system operates without three-dimensional simultaneous localization and mapping or continuous environmental mapping and employs a route-only state estimator for navigation. The system constrains device pose to a curved route corridor derived from a planned route and represents device state using route progress, lateral offset, and relative heading, thereby defining a route-based reference for augmented reality rendering.

The system utilizes a route corridor mesh as a primary reference structure for augmented reality overlay placement. The system applies landmark stamps corresponding to predicted route landmarks to provide soft temporal pose correction based on semantic matching without requiring precise geometry or high-definition maps.

The system allocates sensing responsibilities such that the camera estimates lateral offset and relative heading and inertial and satellite positioning sensors estimate forward progress. The system maintains augmented reality stability during reduced visual reliability by remaining aligned with the route corridor and estimating progress using inertial and satellite positioning data. The system projects augmented reality elements onto a predictive curved representation of the route aligned with future road geometry. The system eliminates world space drift by constraining pose to a pre known route, works at high speed where SLAM fails, avoids computationally expensive 3D mapping, robust in low texture, night time, or visually degraded conditions, and works entirely on mobile devices.

This invention introduces a fundamentally new architecture for augmented reality (AR) navigation that addresses long-standing stability and drift problems without relying on SLAM, world-space tracking, or highly precise maps. Rather than attempting to estimate and maintain a full six-degree-of-freedom (6-DoF) global pose, the system constrains tracking to the structure of the route itself. The result is a SLAM-free, route-anchored AR framework capable of maintaining stable overlays even at highway speeds. The novelty lies not in a single algorithm, but in a coordinated architectural design that combines route-relative state modeling, selective landmark correction, soft geometric constraints, confidence-aware fallback modes, and corridor-bounded feature tracking that is structurally incapable of becoming a SLAM system.

Major inventive concept is the replacement of full 3D world pose estimation with a reduced, route-relative state defined by (s, l, θᵣ): longitudinal progress along the route, lateral offset from the route centerline, and relative heading. Instead of anchoring AR content in global coordinates, the system constrains pose estimation to a curvilinear route-based coordinate frame represented as a corridor mesh or ribbon. This eliminates the need for global drift-prone tracking and significantly reduces computational complexity. No mainstream AR navigation system constrains pose strictly to a route-relative frame in this manner. By anchoring tracking to the route rather than to world coordinates, the system establishes a new class of AR localization that is inherently drift-limiting and structurally SLAM-free.

Another inventive concept is the use of soft semantic landmark corrections governed by multi-stage rejection logic and decaying influence. Landmarks are not applied as hard positional resets. Instead, each candidate landmark must pass several gates, including confidence thresholds, temporal consistency checks, predicted visibility from the route geometry, and yaw agreement. Even after acceptance, corrections are applied incrementally and decay naturally when the landmark is no longer observed. This prevents sudden AR jumps and significantly improves user experience stability. Unlike existing systems that rely on strong, immediate landmark-based pose adjustments, this approach introduces a selective, probabilistic correction model that tightly integrates route geometry and visual semantics.

Further, the system explicitly models map inaccuracy as an expected condition rather than an exception. Instead of treating map geometry as a hard constraint, the estimator incorporates soft geometric priors and slack variables that allow controlled deviation from the mapped route. Visual cues gradually re-align the corridor representation over time. This modeling decision is unusual in AR navigation, where maps are typically assumed to be correct. By designing the estimator to tolerate and compensate for map errors as a first-class feature, the architecture becomes more robust to real-world inconsistencies and imperfect cartographic data.

Another inventive contribution is a structured, multi-source solution to yaw drift on straight roads, a known weakness of visual-inertial odometry systems. The system coordinates vanishing point estimation, IMU bias smoothing, GNSS heading deltas, corridor-bounded feature tracking, and intermittent semantic micro-corrections into a unified stabilization pipeline. The novelty lies not in any individual component, but in the systematic integration of these signals within a route-constrained, SLAM-free framework. This coordinated architecture enables stable heading estimation under conditions where traditional VIO systems typically degrade. Perhaps the strongest patentable distinction is the corridor-bounded, short-lived feature tracking subsystem. Features are tracked only within the predicted route corridor, retained for very short time windows (e.g., one to three seconds), and never persisted into a global map. The system has no loop closure, no anchor storage, and no global coordinate frame. Feature tracks contribute only to lateral and yaw refinement within the route-relative state and are structurally incapable of expanding into a SLAM system. This creates a new middle ground between raw inertial tracking and full map-building SLAM, providing stability benefits while enforcing architectural constraints that prevent map formation.

The system also introduces confidence-and speed-dependent AR mode switching. When vehicle speed becomes too high or tracking confidence drops, the system proactively reduces AR fidelity and simplifies overlay anchoring requirements. This is not merely a visual fallback; the anchoring model itself adapts to reduce spatial precision demands and prevent misleading overlays. Consumer AR systems do not typically degrade their anchoring model based on dynamic confidence and vehicle state. This safety-driven behavior represents a novel integration of state estimation quality with user-facing AR presentation. Taken together, these elements form a complete AR navigation architecture capable of operating at highway speeds without SLAM, without 3D mapping, without persistent world features, and without a global pose. Stable overlays are achieved through route-constrained tracking, selective decaying corrections, soft geometric modeling, and confidence-aware stabilization mechanisms. No existing AR navigation system combines these principles into a coherent, SLAM-free design.

Therefore, the novelty lies in a route-anchored AR navigation framework that maintains overlay stability by constraining tracking to a deformable corridor representation, applying multi-stage decaying landmark corrections, and using short-lived corridor-bound feature tracking that is deliberately incapable of forming a global map.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. An augmented reality-based system for providing navigation, comprising:
a navigation device comprising one or more sensors, wherein the navigation device is associated with a user;
a database configured to store user data, navigation data associated with the navigation device, travel route data including travel routes and landmarks;
a computing device in communication with the navigation device and the database via a network, wherein the computing device comprises a memory storing a set of program modules and a processor configured to execute the program modules, wherein the program modules comprise:
a route module configured to:
receive a route data based on an input travel data, wherein the route data comprises information including a travel route, and
generate a route corridor representation defining a spatial constraint of the travel route, wherein the route corridor representation serves as a spatial reference for determining the location of the navigation device in the travel route during navigation;
a sensor data processing module configured to receive sensor data from one or more sensors;
a tracking module configured to estimate pose of the navigation device relative to the route corridor representation based on the sensor data, wherein the estimated pose comprises a longitudinal position along the travel route, a lateral offset relative to the travel route, and an orientation relative to a direction of the travel route, wherein the sensor data processing module configured to fuse sensor data to update the estimated pose of the navigation device, and
an augmented reality rendering module configured to generate and display navigation related elements anchored along the route corridor representation based on the estimated pose for navigation.

2. The system of claim 1, wherein the sensors comprise at least one of camera, an inertial measurement unit (IMU), a positioning sensor comprising at least one of a global positioning system (GPS) module and a global navigation satellite system (GNSS) module, magnetometer, barometer, and motion sensors.

3. The system of claim 1, wherein the sensors are configured to collect sensor data, wherein the sensor data comprises camera data, motion data including inertial data and position data.

4. The system of claim 1, wherein the route corridor representation comprises a three-dimensional structure extending along the travel route, wherein the three-dimensional structure is selected from the group consisting of a mesh, a spline, a ribbon, a tube, and a parametric surface.

5. The system of claim 1, wherein the sensor data processing module is configured to process sensor data including camera data to extract environmental data including environmental features associated with the travel route, and assign confidence weights to the extracted environmental features and the sensor data,
wherein the system further comprises a landmark module in communication with the sensor data processing module configured to:
detect an environmental feature corresponding to a landmark associated with the travel route, and
perform a soft correction of the estimated pose of the navigation device when the environmental feature corresponds to the landmark and upon satisfaction of confidence and temporal consistency conditions, wherein influence of the correction decays when the landmark is no longer observed.

6. The system of claim 5, wherein the landmark module is configured to:
apply rejection conditions prior to performing pose correction, the rejection conditions comprising at least one of a landmark detection confidence exceeding a predefined threshold, temporal consistency across multiple frames of camera data, agreement with predicted landmark visibility based on progress along the travel route, and agreement with expected camera orientation relative to the route, and
perform the soft correction of the estimated pose when the rejection conditions are satisfied, wherein the correction is applied incrementally to the estimated pose over successive time intervals using a time dependent weighting factor.

7. The system of claim 1, wherein the tracking module in communication with the sensor data processing module configured to monitoring speed and tracking confidence of the navigation device and determine if at least one of speed and tracking confidence is within a predefined threshold,
wherein the AR rendering module in communication with the tracking module is configured to providing an abstract visual representation of the travel route if at least one of the speed and tracking confidence is beyond the predefined threshold,
wherein the AR rendering module is configured to display navigation related elements anchored along the route corridor representation based on the estimated pose if at least one of the speed and tracking confidence is within the predefined threshold, and
wherein the augmented reality rendering module is configured to display navigation related elements positioned based on the estimated pose with spatial alignment corresponding to roadway lane structure.

8. The system of claim 7, wherein the abstract visual representation comprises at least one of abstract directional indicators, route-conforming ribbons without precise lane alignment, and symbolic cues presented with reduced spatial anchoring requirements.

9. The system of claim 1, further comprises a drift management module configured to:
determine a lateral deviation of a position of the navigation device relative to the route corridor representation and an orientation deviation relative to a route direction;
compare the lateral deviation and the orientation deviation to predefined deviation thresholds;
treat the route corridor representation as a soft geometric constraint when the lateral deviation and the orientation deviation are within the predefined deviation thresholds;
correct the estimated pose relative to the travel route using route relative parameters when at least one of the lateral deviation and the orientation deviation exceeds the predefined deviation thresholds, and
apply a drift correction process that gradually adjusts estimated device position relative to the route corridor representation based on visual features observed over time.

10. The system of claim 1, further comprising a corridor bounded visual tracking module configured to:
select visual features within a predicted field of view of the route corridor representation;
track the selected visual features for a limited duration;
determine an orientation observability condition relative to the travel route based on the tracked visual features;
apply supplemental orientation correction when the orientation observability condition satisfies a predefined criterion;
use feature tracking residuals to update lateral offset and orientation relative to the route, and
perform pose estimation without global mapping, loop closure, and simultaneous localization and mapping.

11. An augmented reality-based method for providing navigation, comprising:
providing a navigation device, a database and a computing device in communication with the navigation device and the database, wherein the navigation device comprises one or more sensors and is associated with a user, wherein the database is configured to store user data, navigation data associated with the navigation device, and travel route data including travel routes and landmark, wherein the computing device comprises a memory storing a set of program modules and a processor configured to execute the program modules;
receiving, at the computing device via a route module, a route data based on an input travel data, wherein the route data comprises information including a travel route;
generating, at the computing device via the route module, a route corridor representation defining a spatial constraint of the travel route, wherein the route corridor representation serves as a spatial reference for determining the location of the navigation device in the travel route during navigation;
receiving, at the computing device via a sensor data processing module, sensor data from one or more sensors;
estimating, at the computing device via a tracking module, pose of the navigation device relative to the route corridor representation based on the sensor data, wherein the estimated pose comprises a longitudinal position along the travel route, a lateral offset relative to the travel route, and an orientation relative to a direction of the travel route, wherein the sensor data processing module configured to fuse sensor data to update the estimated pose of the navigation device, and
generating and displaying, at the computing device via an augmented reality rendering module, navigation related elements anchored along the route corridor representation based on the estimated pose for navigation.

12. The method of claim 11, wherein the sensors comprise at least one of camera, an inertial measurement unit (IMU), a positioning sensor comprising at least one of a global positioning system (GPS) module and a global navigation satellite system (GNSS) module, magnetometer, barometer, and motion sensors, wherein the sensors are configured to collect sensor data, wherein the sensor data comprises camera data, motion data including inertial data and position data.

13. The method of claim 11, wherein the route corridor representation comprises a three-dimensional structure extending along the travel route, wherein the three-dimensional structure is selected from the group consisting of a mesh, a spline, a ribbon, a tube, and a parametric surface.

14. The method of claim 11, further comprising the steps of:
processing, at the computing device via the sensor data processing module, sensor data including camera data to extract environmental data including environmental features associated with the travel route;
assigning, at the computing device via the sensor data processing module, confidence weights to the extracted environmental features and to the sensor data;
detecting, at the computing device via a landmark module, an environmental feature corresponding to a landmark associated with the travel route, wherein the landmark module is in communication with the sensor data processing module, and
performing, at the computing device via the landmark module, a soft correction of the estimated pose of the navigation device when the environmental feature corresponds to the landmark and upon satisfaction of confidence and temporal consistency conditions, wherein influence of the correction decays when the landmark is no longer observed.

15. The method of claim 14, further comprising the steps of:
processing, at the computing device via the landmark module, one or more rejection conditions prior to performing pose correction, wherein the landmark module is in communication with the sensor data processing module, the rejection conditions comprising at least one of:
a landmark detection confidence exceeding a predefined threshold′ temporal consistency across multiple frames of camera data;
agreement with predicted landmark visibility based on progress along the travel route, and
agreement with expected camera orientation relative to the route, and
performing, at the computing device via the landmark module, the soft correction of the estimated pose of the navigation device when the rejection conditions are satisfied, wherein the correction is applied incrementally to the estimated pose over successive time intervals using a time dependent weighting factor.

16. The method of claim 11, further comprising the steps of:
monitoring, at the computing device via the tracking module in communication with the sensor data processing module, speed and tracking confidence of the navigation device to determine if at least one of speed and tracking confidence is within a predefined threshold;
providing, at the computing device via the augmented reality rendering module in communication with the tracking module, an abstract visual representation of the travel route if at least one of the speed and the tracking confidence is beyond the predefined threshold;
displaying, at the computing device via the augmented reality rendering module, navigation related elements anchored along the route corridor representation based on the estimated pose if at least one of the speed and the tracking confidence is within the predefined threshold; and
displaying, at the computing device via the augmented reality rendering module, navigation related elements positioned based on the estimated pose with spatial alignment corresponding to roadway lane structure.

17. The method of claim 16, wherein the abstract visual representation comprises at least one of abstract directional indicators, route-conforming ribbons without precise lane alignment, and symbolic cues presented with reduced spatial anchoring requirements.

18. The method of claim 11, further comprising the steps of:
determining, at the computing device via a drift management module, a lateral deviation of a position of the navigation device relative to the route corridor representation and an orientation deviation relative to a route direction;
comparing, at the computing device via the drift management module, the lateral deviation and the orientation deviation to predefined deviation thresholds;
treating, at the computing device via the drift management module, the route corridor representation as a soft geometric constraint when the lateral deviation and the orientation deviation are within the predefined deviation thresholds;
correcting, at the computing device via the drift management module, the estimated pose relative to the travel route using route relative parameters when at least one of the lateral deviation and the orientation deviation exceeds the predefined deviation thresholds; and
applying, at the computing device via the drift management module, a drift correction process that gradually adjusts estimated device position relative to the route corridor representation based on visual features observed over time.

19. The method of claim 11, further comprising the steps of:
selecting, at the computing device via a corridor bounded visual tracking module, visual features within a predicted field of view of the route corridor representation;
tracking, at the computing device via the corridor bounded visual tracking module, the selected visual features for a limited duration;
determining, at the computing device via the corridor bounded visual tracking module, an orientation observability condition relative to the travel route based on the tracked visual features;
applying, at the computing device via the corridor bounded visual tracking module, supplemental orientation correction when the orientation observability condition satisfies a predefined criterion;
updating, at the computing device via the corridor bounded visual tracking module, lateral offset and orientation relative to the route using feature tracking residuals, and
estimating, at the computing device via the corridor bounded visual tracking module, the navigation device pose without performing global mapping, loop closure, and simultaneous localization and mapping.

20. An augmented reality-based system for providing navigation, comprising:
a navigation device comprising one or more sensors, wherein the navigation device is associated with a user;
a database configured to store user data, navigation data associated with the navigation device, and travel route data including travel routes and landmarks;
a computing device in communication with the navigation device and the database via a network, the computing device comprising a memory storing a set of program modules and a processor configured to execute the program modules, the program modules comprising:
a route module configured to:
receive route data based on input travel data, the route data comprising a defined travel route; and
generate a route corridor representation extending along the travel route, the route corridor representation comprising a three-dimensional deformable structure defining a bounded spatial corridor that serves as a sole spatial reference frame for navigation;
a sensor data processing module configured to receive and fuse sensor data from the one or more sensors;
a tracking module configured to:
estimate a pose of the navigation device exclusively relative to the route corridor representation and without estimating or maintaining a global six degree-of-freedom (6-DoF) world pose, wherein the pose is represented in a reduced route-relative state space comprising:
a longitudinal progress parameter corresponding to position along the travel route,
a lateral offset parameter relative to the travel route, and
a heading parameter relative to a direction of the travel route, wherein the tracking module constrains pose estimation to remain within the bounded spatial corridor defined by the route corridor representation, wherein the route corridor representation is treated as a soft geometric constraint permitting bounded deviation from mapped geometry,
wherein the tracking module is further configured to perform route-relative orientation stabilization of the heading parameter by combining multiple independent orientation observability sources comprising: visual vanishing point estimation derived from camera data, inertial measurement unit (IMU) bias smoothing, satellite-based heading change measurements, corridor-bounded visual feature tracking residuals, and intermittent landmark-based orientation corrections, to reduce heading drift during straight-route travel without constructing or maintaining a persistent global map, without loop closure, and without performing simultaneous localization and mapping (SLAM);
an augmented reality rendering module configured to generate and display navigation-related elements anchored to the route corridor representation based solely on the route-relative pose, such that rendered elements are spatially stabilized by the route corridor representation rather than by a global coordinate frame.
